(19) United States
(12) Patent Application Publication
(10) Pub. No.: US 2015/0049328 A1
(43) Pub. Date: Feb. 19, 2015

(54) BIOCHEMICAL ANALYZING SYSTEM AND LIGHT MODULE THEREOF

(71) Applicant: ProtectLife International Biomedical Inc., Taipei City (TW)

(72) Inventor: Chung-Hsien Tsai, Hsinchu (TW)

(21) Appl. No.: 14/376,845

(22) PCT Filed: Jun. 11, 2012
(86) PCT No.: PCT/CN2012/076727

§ 371 Date: Sep. 29, 2014

(51) Int. Cl. G01N 21/25; G01N 21/31; G02B 27/14; G01J 3/28; G02B 27/10; G01N 21/27; G01J 3/02

(52) U.S. Cl. CPC G01N 21/255; G01N 21/27; G01N 21/314; G01J 3/0208; G01J 3/0213; G01J 3/2803; G02B 27/1006; G02B 27/14; G01N 2021/3155; G01N 2201/0618
USPC 356/51; 359/355

(57) ABSTRACT

A light module for a biochemical analyzing system includes a halogen light source emitting light beams, which are guided through a first light path and a second light path and then combined to go through a first beam splitter, so as to analyze a biochemical sample. The first light path includes a plurality of reflective mirrors and a first filter lens, and the first filter lens is used to attenuate an orange band light of the halogen light source. The second light path includes a second filter lens, and the second filter lens is used to attenuate the lights of the halogen light source except the ultraviolet light band.

### RELATED APPLICATIONS

This application is a continuation of International application No. PCT/CN2012/076727 filed Jun. 11, 2012, which is herein incorporated by reference.

### BACKGROUND

1. Field of Invention

The present invention relates to a biochemical analyzing system. More particularly, the present invention relates to an optical biochemical analyzing system.

2. Description of Related Art

The currently used optical light source for a biochemical analyzing system is a xenon lamp. The main reason for the xenon lamp is that the strength comparisons of the xenon lamp emitted lights within the visible range is relatively small, in favor of the implementation of the follow-up analysis. However, the xenon lamp of higher cost is not conducive to the popularity of biochemical analyzing system.

Although the present optical biochemical analyzing system also use a halogen light source of lower cost. However, when requiring to perform the analysis for most of the wavelength of visible light for analysis, it is essential to perform multiple analyzes to complete the full spectrum of visible light, rather than performing the full spectrum of visible light at one time. Some analysis for the full spectrum of visible light of certain terms is not allowed to be executed at multiple times. The strength comparisons of the halogen light in the visible range may be more than 20 times. After a full spectrum of visible light sensing, it will be difficult to perform subsequent analysis or cannot be analyzed.

In view of the above problems, the optical biochemical analyzing system requires a light module solution of lower cost.

### SUMMARY

It is therefore an objective of the present invention to provide an improved light module for a biochemical analyzing system to replace a light module of xenon light source.

In accordance with the foregoing and other objectives of the present invention, a light module for a biochemical analyzing system includes a halogen light source emitting light beams, which are guided through a first light path and a second light path and then combined to go through a first bean splitter, so as to analyze a biochemical sample. The first light path includes a plurality of reflective mirrors and a first filter lens, and the first filter lens is used to attenuate an orange band light of the halogen light source. The second light path includes a second filter lens, and the second filter lens is used to attenuate the lights of the halogen light source except the ultraviolet light band.

According to another embodiment disclosed herein, the reflective mirrors are used to reflect the lights with wavelength between 300 nm and 800 nm.

According to another embodiment disclosed, herein, the first filter lens is located between the halogen light source and the first beam splitter along the first light path.

According to another embodiment disclosed herein, the second filter lens is located between the first beam splitter and the halogen light source along the second light path.

According to another embodiment disclosed herein, the orange band light of the halogen light source has a wavelength above 550 nm.

According to another embodiment disclosed herein, the second filter lens is used to attenuate the lights with wavelength between 320 nm and 400 nm.

According to another embodiment disclosed herein, the light module further includes a second beau splitter for splitting the light beams of the halogen light source to the first light path and the second light path respectively.

According to another embodiment disclosed herein, the first filter lens is located between the first beam splitter and the second beam splitter along the first light path.

In accordance with the foregoing and other objectives of the present invention, a biochemical analyzing system includes a light module and an optical spectrum analyzer. A light module includes a halogen light source emitting light beams passing through a first light path and a second light path and then combined through a first beam splitter to analyze a biochemical sample. The first light path includes a plurality of reflective mirrors and a first filter lens, and the first filter lens is used to attenuate an orange band light of the halogen light source. The second light path includes a second filler lens, and the second filter lens is used to attenuate the lights of the halogen light source except the ultraviolet light band. The optical spectrum analyzer is used to analyze a tight beam passing through the biochemical sample.

According to another embodiment disclosed herein, the optical spectrum analyzer includes an entrance slit, a color dispersion element and a photodiode array. The entrance slit is used to receive the light beams passing through biochemical sample. The color dispersion element is used to expand the spatial dispersion of the light beams passing through the entrance slit. The photodiode array is used to sense the light beams expanded by the color dispersion element.

According to another embodiment disclosed herein, the optical spectrum analyzer includes an entrance slit, a collimating mirror, a color dispersion element, a photodiode array and a condenser lens. The entrance slit is used to receive the light beams passing through biochemical sample. The collimating mirror is used to reflect the light beams passing through the entrance slit. The color dispersion element is used to expand the spatial dispersion of the light beams reflected by the collimating mirror. The photodiode array is used to sense the light beams expanded by the color dispersion element. The condenser lens is used to collect the light beams expanded by the color dispersion element to the photodiode array.

Thus, the biochemical analyzing system disclosed herein merely utilizes single one halogen light source, and a light module is added to improve the optical characteristics of the halogen light source to comply with the optical analyzing demands in the visible spectrum so as to replace a xenon light source of higher costs and other specific wavelengths of light emitting diodes, thereby reducing a total cost of the biochemical analyzing system.

Thus, it is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A illustrates a biochemical analyzing system according to one embodiment of this invention;

FIG. 1B illustrates a biochemical analyzing system according to another embodiment of this invention;

FIGS. 2&3 illustrate the measured data before processed and after processed by a light module of the biochemical analyzing system of this invention;

FIG. 4 illustrates a light module of a biochemical analyzing system according to one embodiment of this invention; and

FIG. 5 illustrates a light module of a biochemical analyzing system according to another embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

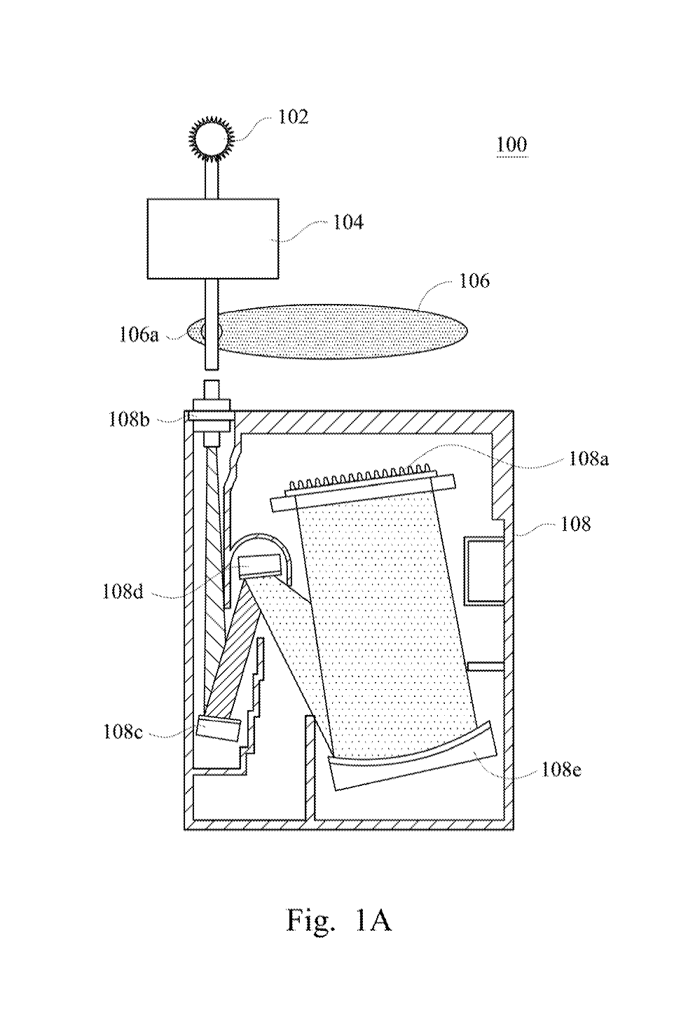

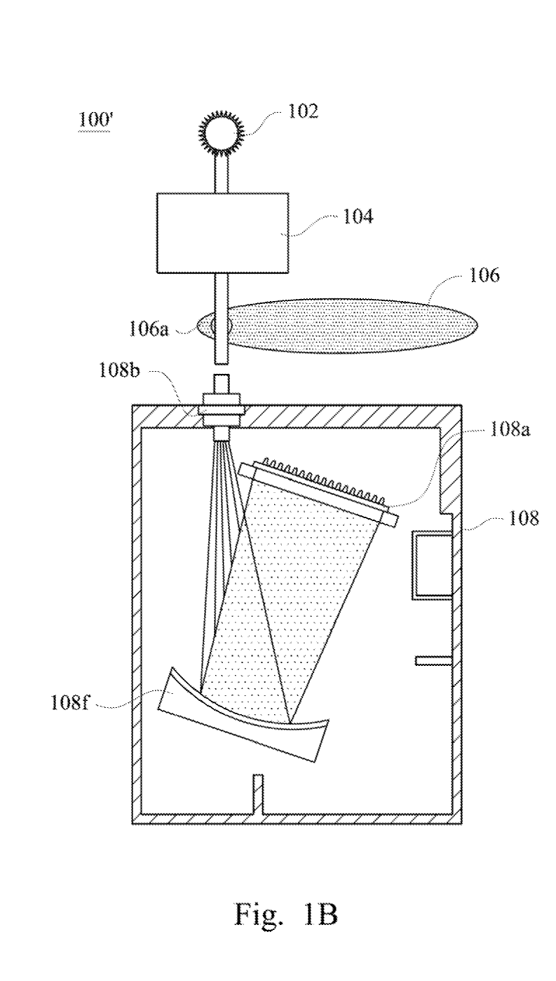

FIG. 1A illustrates a biochemical analyzing system according to one embodiment of this invention. A biochemical analyzing system 100 includes a halogen light source 102, a light module 104 and an optical spectrum analyzer 108 to execute an optical analyzing for a biochemical sample 106a accommodated within a sample carrier 106. The light module 104 is used to adjust the optical characteristics of the halogen light source 102 to comply with the optical analyzing demands. In this embodiment, the optical spectrum analyzer 108 includes an entrance slit 108b, a collimating minor 108c, a color dispersion element 108d, a condenser lens 108e and a photodiode array 108a. The entrance slit 108b is used to receive the light beams passing through the biochemical sample 106a. The collimating mirror 108c is used to reflect the light beams passing through the entrance slit 108b so as to parallel all the light beams to the color dispersion element 108d. The color dispersion element 108d is used to expand the spatial dispersion of the light beams reflected by the collimating mirror 108c to be easily sensed by the photodiode array 108a. The condenser lens 108e is used to collecting the light beams expanded by the color dispersion element 108d to the photodiode array 108a such that the photodiode array 108a can easily sense the light beams.

FIG. 1B illustrates a biochemical analyzing system according to another embodiment of this invention. The biochemical analyzing system 100′ is different from the biochemical analyzing system 100 in that the collimating minor 108c and the color dispersion element 108d are integrated into a single color dispersion element 108f, and the condenser lens 108e is omitted. The color dispersion element 108f is used to expand the spatial dispersion of the light beams passing through the entrance slit 108b and direct the light beams towards the photodiode array 108a. The structures of the optical spectrum analyzer disclosed herein are exemplary, and the present invention is not limited to the embodiment disclosed herein.

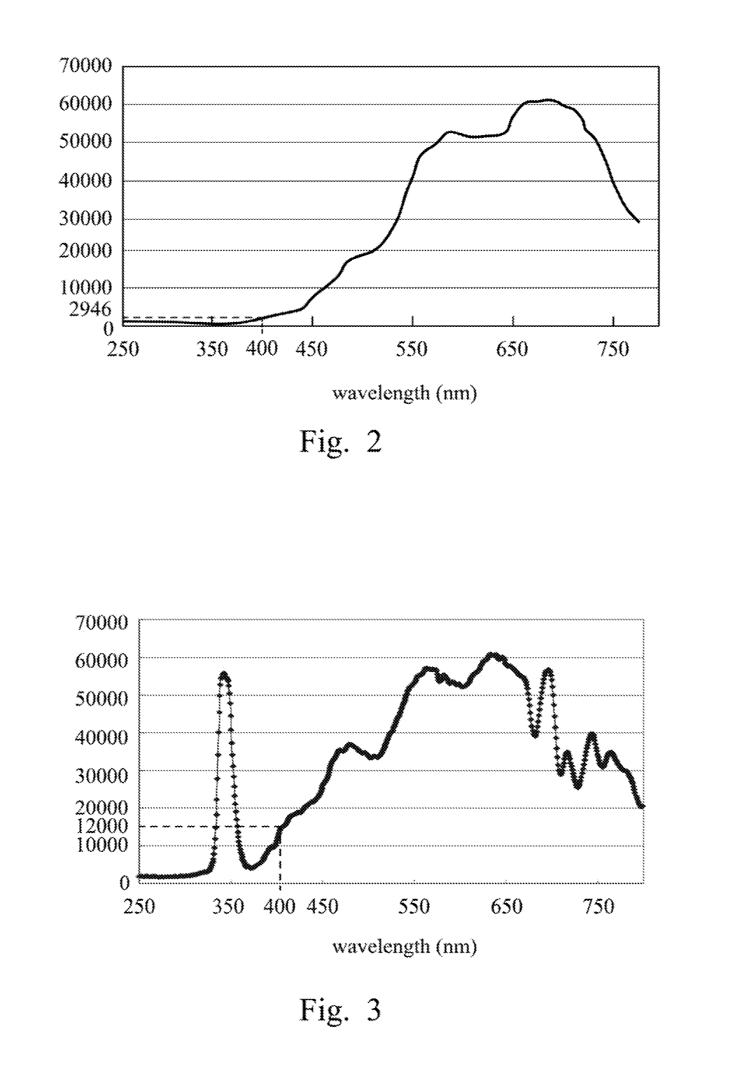

FIGS. 2&3 illustrate the measured data before processed and after processed by a light module of the biochemical analyzing system of this invention vertical axis is the relative intensity value, and there is no absolute units), FIG. 2 illustrates the measured data before the halogen light source is processed by the light module, and FIG. 3 illustrates the measured data after the halogen light source is processed by the light module. Referring to FIG. 2, when the halogen light source is unprocessed, the strength comparisons of the emitted lights will be more than 20 times within the visible range (wavelength between 400 nm and 750 nm), e.g., strength value 60000/2946>20. When the photodiode array is used to sense a visible range of the spectrum at one time, it is difficult to analyze the spectrum due to factors that signal to noise ratio is too high. Therefore, a light module, e.g., light module 104, can be installed into the biochemical analyzing system to process the halogen light source, such that the measured result of FIG. 3 can be obtained. Referring to FIG. 3, when the halogen light source is processed by the light module, e.g., light module 104, the strength comparisons of the emitted lights will be less than 5 times in the visible range (wavelength between 400 nm and 750 nm), e.g., strength value 60000/12000<5, and it will be easier to analyze the spectrum. Various light module examples are explained below with drawings. In addition, the light module 104 is equipped with extra blue-violet light source, thereby increasing the light intensity around the wavelength 400 nm.

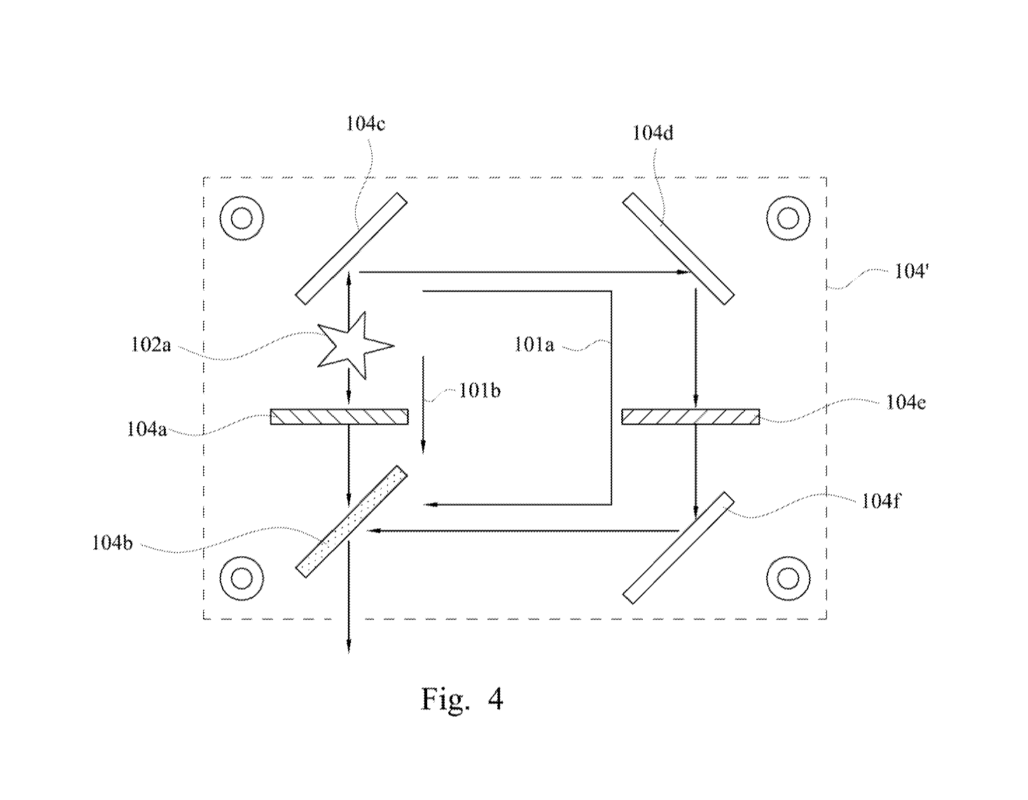

FIG. 4 illustrates a light module of a biochemical analyzing system according to one embodiment of this invention. A light module 104′ includes a single halogen light source 102a emitting light beams, which are passed through a first light path 101a and a second light path 101b and then combined through a first beam splitter 104b to analyze a biochemical sample, e.g., biochemical sample 106a in FIG. 1A. The first light path 101a includes a plurality of reflective mirrors and a first filter lens 104e, and the first filter lens 104e is used to attenuate an orange band light (i.e., wavelength more than 550 nm) of the halogen light source. The second light path 101b includes a second filter lens 104a, and the second filter lens 104a is used to attenuate the lights of the halogen light source 102a except the ultraviolet light band (i.e., wavelength between 320 nm and 400 nm). In this embodiment, the first filter lens 104e may be located between the halogen light source 102a and the first beam splitter 104b along the first light path 101a, and the second filter lens 104a may be located between the first beam splitter 104b and the halogen light source 102a along the second light path 101b. In this embodiment, the reflective mirrors (104c, 104d, 104f) can be reflective mirrors reflecting lights with wavelength between 300 nm and 800 nm or other suitable reflective mirrors. In addition, the number of the reflective mirrors (104c, 104d, 104f) is not limited, and can be varied according the demands of the light module.

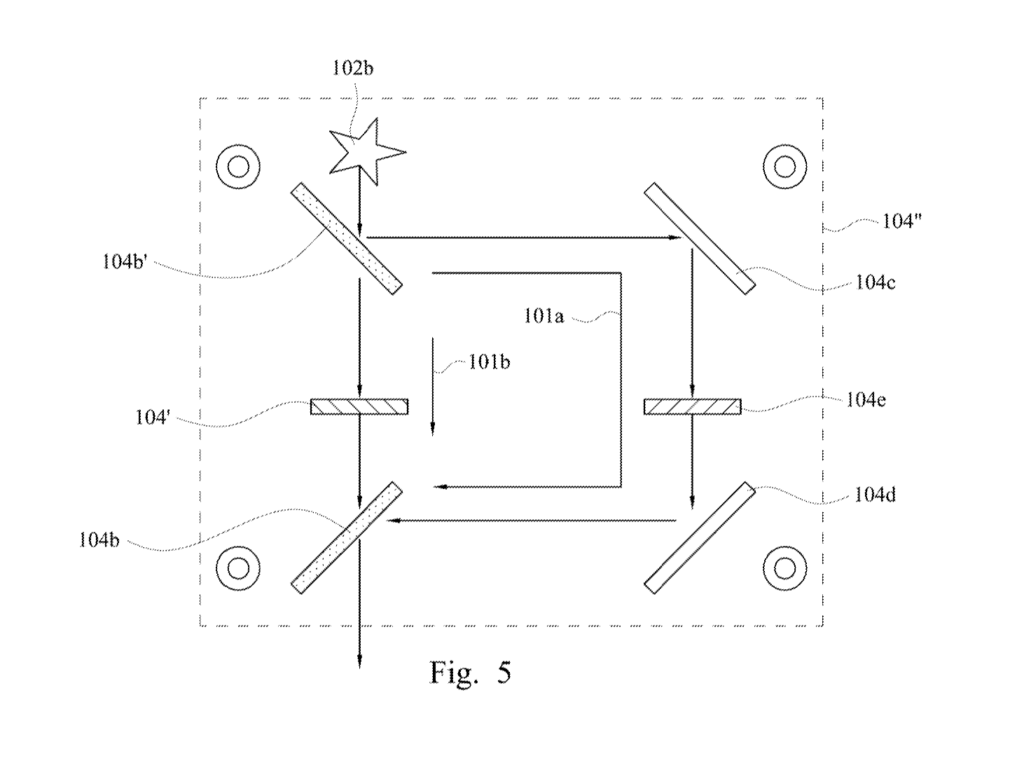

FIG. 5 illustrates a light module of a biochemical analyzing system according to another embodiment of this invention. The light module 104″ is different from the light module 104′ in that a second beam splitter 104b′ is added. The light module 104″ includes a single halogen light source 102b emitting beams, which are passed through the first light path 101a and the second light path 101b and then combined through the first beam splitter 104b to analyze a biochemical sample, e.g., biochemical sample 106a in FIG. 1A. The added second beam splitter 104b′ is used to split the light beams of the halogen light source 102b to the first light path 101a and the second light path 101b respectively. The first light path 101a includes a plurality of reflective mirrors and a first filter lens 104e, and the first filter lens 104e is used to attenuate an orange band light (i.e., wavelength more than 550 nm) of the halogen light source. The second light path 101b includes a second filter lens 104a, and the second filter lens 104a is used to attenuate the lights of the halogen light source 102b except the ultraviolet light band (i.e., wavelength between 320 nm and 400 nm). In this embodiment, the first filter lens 104e may be located at any position between the first beam splitter 104b and the second beam splitter 104b′ along the first light path 101a, and the second filter lens 104a may be located between the first beam splitter 104b and the second beam splitter 104b′ along the second light path 101b. In this embodiment, the reflective mirrors (104c, 104d) can he reflective mirrors reflecting lights with wavelength between 300 nm and 800 nm or other suitable reflective mirrors. In addition, the number of the reflective mirrors (104c, 104d) is not limited, and can be varied according the demands of the light module.

According to the above-discussed embodiments, the biochemical analyzing system disclosed herein merely utilizes single one halogen light source, and a light module is added to improve the optical characteristics of the halogen light source to comply with the optical analyzing demands in the visible spectrum so as to replace a xenon light source of higher costs and other specific wavelengths of light emitting diodes, thereby reducing a total cost of the biochemical analyzing system.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A light module for a biochemical analyzing system comprising:
a halogen light source emitting light beams, which are guided through a first light path and a second light path and then combined to go through a first beam splitter, so as to analyze a biochemical sample;
the first light path comprises a plurality of reflective mirrors and a first filter lens, the first filter lens is used to attenuate an orange band light of the halogen light source; and
the second light path comprises a second filter lens, the second filter lens is used to attenuate the lights of the halogen light source except the ultraviolet light band.

2. The light module of claim , wherein the reflective mirrors are used to reflect the lights with wavelength between 300 nm and 800 nm.

3. The light module of claim 1, wherein the first filter lens is disposed between the halogen light source and the first beam splitter along the first light path.

4. The light module of claim 1, wherein the second filter lens is disposed between the first beam splitter and the halogen light source along the second light path.

5. The light module of claim 1, wherein the orange band light of the halogen light source has a wavelength above 550 nm.

6. The light module of claim 1, wherein the second filter lens is used to attenuate the lights with wavelength between 320 nm and 400 nm.

7. The light module of claim 1 further comprising a second beam splitter for splitting the light beams of the halogen light source to the first light path and the second light path respectively.

8. The light module of claim 7, wherein the first filter lens is disposed between the first beam splitter and the second beam splitter along the first light path.

9. A biochemical analyzing system comprising:
a light module comprising:
a halogen light source emitting light beams, which are guided through a first light path and a second Hot path and then combined, to go through a first beam splitter, so as to analyze a biochemical sample;
the first light path comprises a plurality of reflective mirrors and a first filter lens, the first filter lens is used to attenuate an orange band light of the halogen light source; and
the second light path comprises a second filter lens, the second filter lens is used to attenuate the lights of the halogen light source except the ultraviolet light band; and
an optical spectrum analyzer for analyzing to light bean passing through the biochemical sample.

10. The biochemical analyzing system of claim 9, wherein the reflective mirrors are used to reflect the lights with wavelength between 300 mu and 800 nm.

11. The biochemical analyzing system of claim 9, wherein the first filter lens is disposed between the halogen light source and the first beam splitter along the first light path.

12. The biochemical analyzing system of claim 9, wherein the second filter lens is disposed between the first beam splitter and the halogen light source along the second light path.

13. The biochemical analyzing system of claim 9, wherein the orange band light of the halogen light source has a wavelength above 550 nm.

14. The biochemical analyzing system of claim 9, wherein the second filter lens is used to attenuate the lights with wavelength between 320 nm and 400 nm.

15. The biochemical analyzing system of claim 9 further comprising a second beam splitter for splitting the lights of the halogen light source to the first light path and the second light path respectively.

16. The biochemical analyzing system of claim 15, wherein the first filter lens is disposed between the first beam splitter and the second beam splitter along the first light path.

17. The biochemical analyzing system of claim 9, wherein the optical spectrum analyzer comprises:
an entrance slit for receiving the light beams passing through the biochemical sample;
a color dispersion element for expanding the spatial dispersion of the light beams passing through the entrance slit; and
a photodiode array for sensing the light beams expanded by the color dispersion element.

18. The biochemical analyzing system of claim 9, wherein the optical spectrum analyzer comprises:
an entrance slit for receiving the light beams passing through the biochemical sample;
a collimating mirror for reflecting the light beams passing through the entrance slit;
a color dispersion element for expanding the spatial dispersion of the light beams reflected by the collimating mirror;
a photodiode array for sensing the light beams expanded by the color dispersion element; and
a condenser lens for collecting the light beams expanded by the color dispersion element to the photodiode array.
